(19) United States
(12) Patent Application Publication
(10) Pub. No.: US 2012/0169052 A1
(43) Pub. Date: Jul. 5, 2012

(54) Wind Power Plant with a plurality of Wind Power Devices and Method for Controlling the Wind Power Plant

(75) Inventors: Reiner Leipold-Buettner, Bad Hersfeld (DE); Heinz-Josef Tenberge, Sprockhovel (DE); Volker Knoblauch, Stuttgart (DE); Bernhard Menz, Berlin (DE)

(73) Assignee: ROBERT BOSCH GMBH, Stuttgart (DE)

(21) Appl. No.: 13/381,165

(22) PCT Filed: May 31, 2010
(86) PCT No.: PCT/EP2010/003297

§ 371 Date: Mar. 23, 2012

(30) Foreign Application Priority Data
Jun. 29, 2009 (DE) 10 2009 030 886.5

(51) Int. Cl. H02P 9/04

(52) U.S. Cl. 290/44

(57) ABSTRACT

A wind power plant for converting wind power of a wind field into electrical energy. The wind power plant includes at least one wind power device having a wind measurement device. Furthermore, the wind power plant comprises a central storage device in which wind profile patterns are stored in a wind profile pattern table. The wind measurement device predictively detects current wind measurement values. The wind power plant has a central pattern recognition device that correlates the current wind measurement values of the wind measurement device with the stored wind profile patterns of the wind profile pattern table. A central control device individually controls each single wind power device of the wind power plant as a function of a wind profile pattern determined by correlation.

The invention relates to a wind energy installation for conversion of wind energy in a wind field to electrical energy having a multiplicity of wind energy apparatuses, and to a method for controlling the wind energy installation. For this purpose, the wind energy installation has at least one wind energy apparatus, which has a wind measurement apparatus.

The document DE 101 37 272 A1 discloses an early warning system for wind energy installations or wind farms which have a multiplicity of wind energy apparatuses. For the early warning system, measurement data from a first wind energy apparatus in the wind farm, with this wind energy apparatus being that which is subject to the wind first of all, is transmitted to at least one second wind energy apparatus, which is behind the first wind energy apparatus in the wind direction. In the early warning system, the second wind energy apparatus, which is in the wind shadow of the first wind energy apparatus, is controlled as a function of the measured data relating to the wind situation in the area of the first wind energy apparatus.

This makes use of the knowledge that not only, as in the past, the wind conditions can be measured at a single wind energy apparatus by means of an anemometer, but that these measurement results can also be used for wind energy apparatuses which are arranged behind the first wind energy apparatus in the wind direction, such that they can implement a blade setting angle change when necessary, for example when gusts occur, in good time before the gust arrives at the wind farm, as a result of which the load when the gust arrives at the wind farm is not sufficiently great that this could lead to damage to wind energy apparatuses.

An early warning system such as this has the disadvantage that it protects the wind energy apparatuses in the wind energy installation only in extreme wind profile situations, such as a storm warning or a gust warning. However, this system is not able to individually control the wind energy apparatuses in the wind farm or the wind energy installation so as to allow optimum use of the wind energy installation with normal wind profiles as well.

The object of the invention is to overcome the disadvantages in the prior art and to specify a wind energy installation having a multiplicity of wind energy apparatuses for conversion of wind energy in a wind field to electrical energy, and to specify a method for controlling the wind energy installation such that, on the one hand, the multiplicity of wind energy apparatuses in the wind energy installation are protected against damage and, on the other hand, the energy yield can be optimally adapted, with the wind energy apparatuses having a long life.

This object is achieved by the subject matter of the independent claims. Advantageous developments are specified in the dependent claims.

According to the invention, a wind energy installation is provided for conversion of wind energy in a wind field to electrical energy having a multiplicity of wind energy apparatuses, and a method is provided for controlling the wind energy installation. For this purpose, the wind energy installation has at least one wind energy apparatus which has a wind measurement apparatus for predictive measurement of wind profiles. Furthermore, the wind energy installation has a central storage apparatus in which a multiplicity of wind profile patterns are stored in a wind profile pattern table.

The wind measurement apparatus predictively detects current wind measured values. The wind energy installation has a central pattern recognition apparatus which correlates the current wind measured values from the wind measurement apparatus with the stored wind profile patterns from the wind profile pattern table. A central control device individually controls each individual wind energy apparatus in the wind energy installation as a function of a wind profile pattern, which is determined by correlation.

A wind energy installation such as this has the advantage that, during operation of a wind farm having a multiplicity of wind apparatuses, all the wind apparatuses which belong to the wind farm can be controlled individually with minimal measurement effort. The storage of wind profile patterns in a central store for the wind installation makes it possible to provide, in the stored wind profile pattern table itself, and to take account of, the geographical characteristics of the region of operation of the wind energy installation, such as hillsides, canyons, elevated positions, forest firebreaks and other geographical characteristics in which the individual wind energy apparatus operates in a wind energy installation.

It is thus possible, on a hillside, to set those wind energy apparatuses which are positioned toward the hill to a lower rotor blade angle of attack because of the higher wind speed, while the wind energy apparatuses which are arranged toward the valley can still be operated with a higher angle of attack. The angles of attack of the rotor blades are also in general referred to as the “pitch”.

These geographically dependent differences within the region of operation of the wind energy installation or of the wind farm can even lead to some of the rotor blades in the wind energy installation already being set to a feathered position, for the sake of safety, while other areas of the wind energy installation can be maintained in full operation. In order to allow this, at least one of the wind energy apparatuses is preferably provided for predictive detection of an active wind profile. However, in extreme geographical conditions, a plurality of the multiplicity of wind energy apparatuses may also be equipped with appropriate wind measurement apparatuses, which are each arranged at extreme locations at the edge of the wind farm.

However, the number of wind energy apparatuses in the wind energy installation is preferably greater than the number of wind measurement apparatuses being operated. This makes it possible to achieve a considerable cost reduction. Furthermore, this results in the entire wind energy installation or wind farm being matched to the wind conditions at an early stage, by matching the pitch on the one hand and the pitch angle of each individual installation on the other hand in each case optimally and appropriately to the determined wind profile pattern.

In order to achieve a safe and reliable correlation between predictively measured current wind measured values and the stored wind profile patterns, it is advantageous to detect a multiplicity of wind profiles as a wind profile pattern in the region of operation of the wind energy installation. The multiplicity of detected wind profile patterns makes it possible to ensure that the wind energy installation optimally matches the individual wind apparatuses to the wind conditions, even in extraordinary wind conditions.

In order to predictively determine the current values, the wind energy installation has a predictive wind sensor system as the wind measurement apparatus, preferably a SODAR (sound detection and ranging) or a LIDAR (light detection and ranging) anemometer. These wind sensor systems can preferably be mounted on the hub of the rotor of that wind energy apparatus in the wind energy installation which is equipped with the wind measurement system, since it can then cover the area and the wind conditions without any disturbance, at a time before they arrive, and physically upstream of the wind energy apparatus. It is therefore also advantageous for the individual wind energy apparatus which is equipped with a wind measurement apparatus such as this to be arranged at an exposed location in the wind farm or the wind energy installation.

In one preferred embodiment of the invention, the wind energy apparatuses in the wind energy installation each have an apparatus for pitch angle adjustment of a nacelle to which a rotor is fitted, and the respective control device sets the pitch angle of the nacelle in reaction to wind profile pattern recognition. The invention also provides that the wind energy apparatuses in the wind energy installation each have an apparatus for adjusting the angle of attack of rotor blades, and the respective control device sets the angle of attack or pitch of the rotor blades in reaction to wind profile pattern recognition. Finally, each wind energy apparatus in the wind energy installation has an azimuth adjustment apparatus in order to rotate the rotor blades to the respective wind direction, with the aid of the nacelle.

Furthermore, it is possible for the wind energy apparatuses in the wind energy installation to have a braking apparatus in the drive train for braking the rotor, and the respective control device to set the rotor blades to the feathered position, and to brake the rotor, in reaction to wind profile pattern recognition with a storm or gust warning. As already mentioned above, this can, however, be provided in an advantageous manner only for specific exposed positions of wind energy apparatuses in the wind farm, using the wind energy installation according to the invention, when the conditions of a wind profile require this, while other areas are still operating.

A method for controlling a wind energy installation having at least one wind energy apparatus has the following method steps. First of all, a multiplicity of wind profiles are detected by a multiplicity of wind measurement apparatuses in a geographical region of operation of the wind energy installation, preferably even before individual wind energy apparatuses are constructed. The multiplicity of wind profiles are stored in a central storage apparatus in the wind profile installation in the form of wind profile patterns in a wind profile pattern table.

Finally wind measured values are detected and evaluated, currently and predictively, with the aid of a predictive wind measurement apparatus by at least one wind energy apparatus in the wind farm, after it has been constructed. For this purpose, the current wind measured values are correlated with a wind profile pattern in the wind profile pattern table, by means of pattern recognition methods. The wind energy apparatuses in the wind energy installation can then each be operated individually, thus making it possible to match the loads on the components of the wind energy apparatuses and the energy yield of the wind energy apparatuses optimally to the wind profiles.

A central control device for the wind farm, for each individual wind energy apparatus in the wind energy installation, can set a pitch angle of a rotor and/or of a nacelle, taking account of reactive load measurements on the components in the wind energy apparatus, in reaction to wind profile pattern recognition. It is also possible to in each case set different angles of attack or rotor blade pitches for individual wind energy apparatuses, taking account of reactive load measurements on the components in the individual wind energy apparatus, with the aid of the control device and in reaction to wind profile pattern recognition, with the azimuth angle, the pitch and the pitch angle being regulated as a function of the wind profile pattern recognition.

Furthermore, the respective control device for each individual wind energy apparatus in the wind energy installation can appropriately vary damping of oscillations in a drive train in reaction to wind profile pattern recognition, in order to minimize such oscillations. Finally, the invention provides for the respective control device for each individual wind energy apparatus in the wind energy installation to set the rotor blades to the feathered position, and to brake the rotor by means of a braking apparatus in the braking train, in reaction to wind profile pattern recognition with a storm warning. However, this is envisaged only for protection of the individual energy apparatus in the case of extreme wind profiles.

The invention will now be explained in more detail with reference to the attached figures, in which:

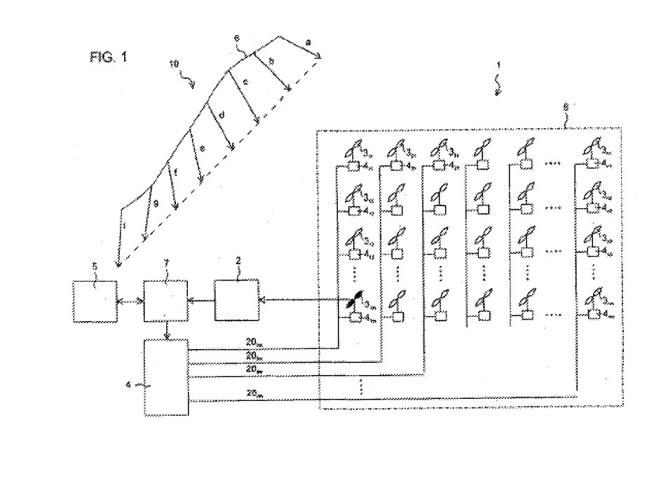

FIG. 1 shows an outline sketch of a wind energy installation having a multiplicity of wind energy apparatuses according to one embodiment of the invention;

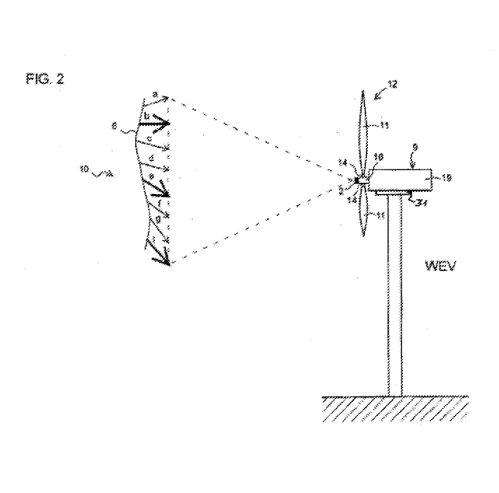

FIG. 2 shows an outline sketch of a wind energy apparatus for the embodiment of a wind energy installation shown in FIG. 1;

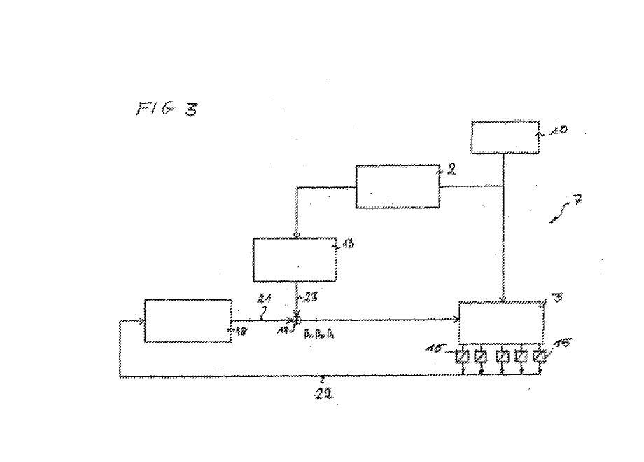

FIG. 3 shows a control device for the wind energy apparatus shown in FIG. 2;

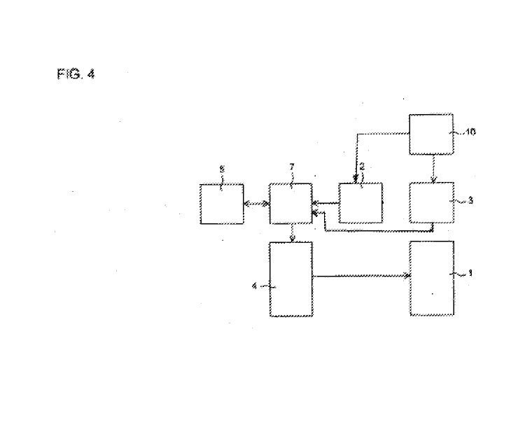

FIG. 4 shows an outline sketch of a central control device for the wind energy installation shown in FIG. 1; and

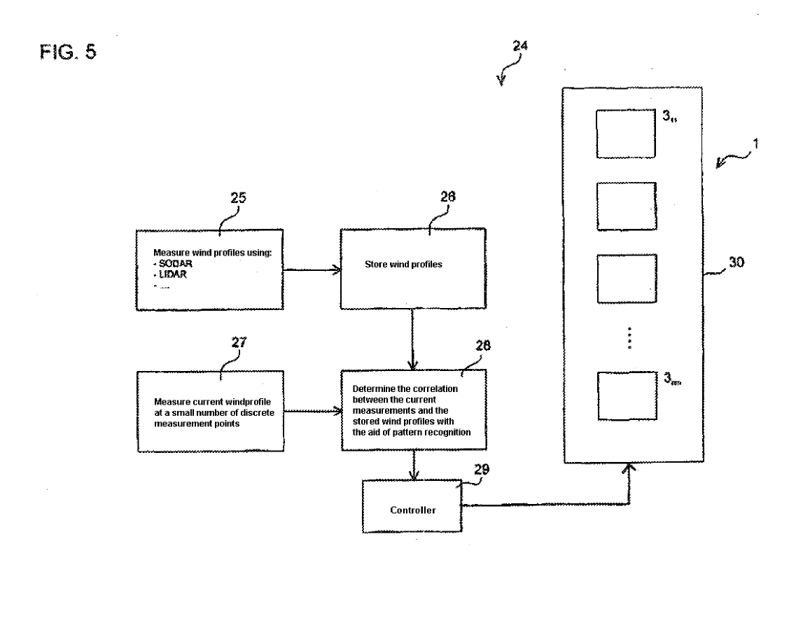

FIG. 5 shows a schematic flow chart for the central control of the wind energy installation according to the invention shown in FIG. 1.

FIG. 1 shows an outline sketch of a wind energy installation 1 having a multiplicity of wind energy apparatuses 3₁₁ to 3ₙₘ according to one embodiment of the invention. The wind energy installation 1 with its multiplicity of wind energy apparatuses 3₁₁ to 3ₙₘ, which are installed in the region of operation 8, is subject to a current wind field 10, which has different wind directions a to h and different wind strengths in accordance with the wind profile 6.

At least one wind energy apparatus 3 of the multiplicity of wind energy apparatuses 3₁₁ to 3ₙₘ preferably has a wind measurement apparatus which can predictively detect current wind measured values. These current wind measured values are correlated by a central pattern recognition apparatus 7 with a multiplicity of wind profile patterns stored in a wind profile pattern table in a central storage apparatus 5.

These profile patterns have the wind speeds and wind directions to be expected for each of the wind energy apparatuses 3₁₁ to 3ₙₘ in the region of operation 8. Instead of a fixed association between a wind measurement apparatus and one of the wind energy apparatuses, it is also possible for one or more of the wind measurement apparatuses to be provided independently of the individual wind energy apparatuses in the area of the wind energy installation.

Individual control devices 4₁₁ to 4ₙₘ, which are arranged at the wind energy apparatuses 3₁₁ to 3ₙₘ, are supplied with control signals ₘ by a central control unit 4, such that each wind energy apparatus 3₁₁ to 3ₙₘ can be set for the wind strength and wind direction to be expected. For this purpose, the control unit 4 has appropriate control lines 20₁₁ to 20ₙₘ and one or more bus lines, via which control signals can be transmitted to the multiplicity of wind energy apparatuses 3₁₁ to 3ₙₘ in the wind energy installation 1, using a multiplexing method.

FIG. 2 shows an outline sketch of a wind energy apparatus 3 for a wind energy installation 1 according to the embodiment in FIG. 1. For this purpose, the stationary wind energy apparatus 3 has a rotor 12 and a nacelle 9, which has further components 19 of the wind energy apparatus 3 for conversion of wind energy to electrical energy. The wind energy apparatus 3 in the wind energy installation 1 is for this purpose arranged in a wind field 10 which is detected with the aid of a predictive wind measurement apparatus 2, which is arranged on the hub 16 of the rotor 12, with the wind directions a to h and different wind speeds, as indicated by the wind profile 6. The predictively measured wind conditions as well as the measured shock and pivoting moments of the rotor blades 11 and the pitch and yaw moments of the nacelle 9 are taken into account in the closed-loop pitch control and are set by the appropriate angle of attack adjustment 14 for the rotor blades 11 of the rotor 12. In addition, an azimuth adjustment apparatus 31 rotates the rotor to the respective wind direction, with the aid of the nacelle. The load limit values for the components 19 of the wind energy apparatus 3 are also taken into account in this case.

FIG. 3 shows one of these local control devices 4 for the wind energy apparatus 3 when subject to the influence of a wind field 10, which is measured at a distance upstream of the wind energy apparatus 3. The stationary wind energy apparatus 3 is in this embodiment of the invention a wind power apparatus which, for example, has an IPC regulator 18 (individual pitch control) which sets different pitch angles on the rotor blades, for example β₁, β₂ and β₃ for a three-blade rotor.

As input signals, the IPC regulator receives loads on the wind energy apparatus 3 measured by sensors 15, such as blade root bending moments in the shock and/or pivoting direction, yaw and/or pitch moments on the rotor shaft etc., and is designed such that it minimizes the measured loads and/or characteristic variables derived from this, by adjusting the individual pitch angles. However, the IPC regulator is initially reactive, as a result of which it reacts only when a load has already been measured. According to the invention, as FIGS. 2 and 3 show, a wind field 10 is now measured according to the invention upstream of the wind energy apparatus 3, by a wind measurement apparatus 2 with, for example, a SODAR (sound detection and ranging) or a LIDAR (light detection and ranging) anemometer. The disturbance variable application 13 calculates from this how the pitch angles β₁, β₂ and β₃ of the rotor blades must be set when the wind field arrives in order to minimize the loads and characteristic variables mentioned above.

These calculated pitch angles β₁, β₂ and β₃ are now set by the wind energy apparatus 3. This signal path is predictive, that is to say it reacts by means of the disturbance variable application 13 before any loads can be reactively measured at all. In this case, the wind energy apparatus 3 is set such that, at the moment when the measured wind arrives, the loads on the components remain within the desired limits, with the maximum possible energy yield. This disturbance variable application 13 now results in considerably lighter loads being applied to the wind energy apparatus 3.

The loads cannot be avoided completely, since the wind field 10 changes before it arrives at the wind energy apparatus 3, and model errors cannot be precluded. The IPC regulator 18 for each individual wind energy apparatus now has to regulate out only these lighter loads via a signal path 21, with the sensor values from the sensors 15 being made available in the IPC regulator 18 via the signal line 22. Overall, a considerable load reduction is possible in comparison to conventional wind energy apparatuses 3, in which a regulator 18 such as this has to manage without any disturbance variable application 13. In this case, the two signal paths 21 and 23 are joined together at the adder 17.

FIG. 4 shows an outline sketch of a central control device for the wind energy installation 1 shown in FIG. 1. The wind field 10 is detected by the wind energy apparatus 3, which is equipped with a LIDAR (light detection and ranging) anemometer as the wind measurement apparatus 2, and this is supplied to the pattern recognition apparatus 7, which correlates the actively measured wind field with corresponding wind profile patterns stored in a storage apparatus 5, and supplies one of the multiplicity of stored wind profile patterns, which comes closest to the current wind field 10, to a central control device 4. This central control unit supplies the individual and local control units for the rest of the wind energy apparatuses 3₁₁ and 3ₙₘ, as is shown in FIG. 1, with appropriate control signals for optimization of the energy yield and for protection against excessive loads on the wind energy installations 3₁₁ and 3ₙₘ.

FIG. 5 shows a schematic flowchart of the central control of the wind energy installation 1 according to the invention, as shown in FIG. 1. A multiplicity of wind profiles are measured in block 25 with the aid of SODAR or LIDAR anemometers, and this multiplicity of wind profiles are stored in block 26. In block 28, this multiplicity of wind profiles are available for correlation between current measurements and stored wind profiles, by means of a pattern recognition method. For this purpose, the current wind profile, which has been detected predictively at a small number of discrete measurement points in the region of operation of the wind power installation, is supplied to the block 28 from the block 27, and is correlated.

The result, in the form of one of the stored wind profile patterns, is converted by block 29 in a central controller to a multiplicity of control commands, which are transmitted to each of the energy apparatuses 3₁₁ and 3ₙₘ shown in block 30, such that these wind energy installations 3₁₁ and 3ₙₘ can be individually set to the current wind profile.

### LIST OF REFERENCE SYMBOLS

1 Wind energy installation
2 Wind measurement apparatus
3 Wind energy apparatus
4 Control device
5 Storage apparatus
6 Wind profile
7 Pattern recognition apparatus
8 Region of operation
9 Nacelle
10 Wind field
11 Rotor blade
12 Rotor
13 Disturbance variable application
14 Angle of attack adjustment
15 Sensor
16 Hub
17 Adder
18 Regulator
19 Components
20 Control line
21 Signal path
22 Signal line
23 Signal path
24 Flowchart
25 Block in the flowchart
26 Block in the flowchart
27 Block in the flowchart
28 Block in the flowchart
29 Block in the flowchart
30 Block in the flowchart
31 Azimuth adjustment apparatus

1. A wind energy installation comprising:
a plurality of wind energy apparatuses for conversion of wind energy of a wind field to electrical energy by at least one wind energy apparatus which has a wind measurement apparatus configured to predictively detect current wind measured values;
a central storage apparatus in which a plurality of wind profile patterns are stored in a wind profile pattern table;
a pattern recognition apparatus which correlates the current wind measured values with the wind profile patterns stored in the wind profile pattern table; and
a central control device configured to individually control each individual wind energy apparatus in the wind energy installation as a function of a wind profile pattern, which is determined by correlation.

2. The wind energy installation as claimed in claim 1, wherein the number of wind energy apparatuses in the wind energy installation is the same as, but preferably greater than the number of the wind measurement apparatuses being operated.

3. The wind energy installation as claimed in claim 1, wherein a plurality of wind profiles are detected as a wind profile pattern in a region of operation of the wind energy installation.

4. The wind energy installation as claimed in claim 1, wherein the wind energy installation has a predictive wind sensor system as the wind measurement apparatus, preferably a SODAR or a LIDAR anemometer.

5. The wind energy installation as claimed in claim 1, wherein:
the wind energy apparatuses each have an apparatus for a pitch angle adjustment of a nacelle to which a rotor is fitted, and
the respective central control device sets the pitch angle of the nacelle in reaction to wind profile pattern recognition.

6. The wind energy installation as claimed in claim 1, wherein:
the wind energy apparatuses each have an apparatus for adjusting a pitch angle of rotor blades, and
the respective central control device sets the pitch angle or pitch of the rotor blades in reaction to wind profile pattern recognition.

7. The wind energy installation as claimed in claim 1, wherein:
the wind energy apparatuses include a braking apparatus in the drive train for braking the rotor, and
the respective central control device sets the rotor blades to a feathered position and brakes the rotor in reaction to wind profile pattern recognition with a storm warning.

8. A method for controlling a wind energy installation having at least one wind energy apparatus, comprising:
detecting a plurality of wind profiles in a geographical region of operation of the wind energy installation;
storing the plurality of wind profiles in a central storage apparatus in the form of wind profile patterns in a wind profile pattern table;
detecting current predictive wind measured values with the aid of a predictive wind measurement apparatus;
correlating the current wind measured values with a wind profile pattern in the wind profile pattern table, by means of pattern recognition methods; and
individually operating the wind energy apparatuses in a wind energy installation.

9. The method as claimed in claim 8, wherein a greater number of wind measurement apparatuses are used for detecting the plurality of wind profiles than for detecting the current predictive wind measurements.

10. The method as claimed in claim 8, wherein a predictive wind sensor system is used as the wind measurement apparatus, preferably a SODAR or a LIDAR anemometer.

11. The method as claimed in claim 8, wherein a central control device of each individual wind energy apparatus sets a pitch angle of a rotor and/or of a nacelle, taking account of reactive load measurements of components in the wind energy apparatus, in reaction to wind profile pattern recognition.

12. The method as claimed in claim 8, wherein a central control device of each individual wind energy apparatus sets an angle of attack or pitch of rotor blades taking account of reactive load measurements on components in the wind energy apparatus in reaction to wind profile pattern recognition.

13. The method as claimed in claim 8, wherein a respective control device of each individual wind energy apparatus varies damping of oscillations in a drive train in reaction to wind profile pattern recognition.

14. The method as claimed in claim 8, wherein a respective control device of each individual wind energy apparatus sets the rotor blades to the feathered position, and brakes the rotor by means of a braking apparatus in a braking train, in reaction to wind profile pattern recognition.
